(19) United States
(12) Patent Application Publication
(10) Pub. No.: US 2007/0277248 A1
(43) Pub. Date: Nov. 29, 2007

(54) Installation of an Application Module and a Temporary Certificate

(75) Inventors: Sachin K. Agrawal, Redmond, WA (US); Trevor Foucher, Seattle, WA (US); Wesley O. Pereira, Seattle, WA (US); Erik Mavrinac, Bothell, WA (US); Luke Abrams, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/420,351

(22) Filed: May 25, 2006

(51) Int. Cl. G06F 17/30

(52) U.S. Cl. 726/30

(57) ABSTRACT

Techniques to install an application module and a temporary certificate are described. In an implementation, an application module is installed on a client device. When online access is available, a temporary certificate is obtained anonymously from a service provider to enable one or more online components of the application module for a predetermined amount of time. An input may also be received to communicate credentials of the user to obtain a permanent certification.

### BACKGROUND

Digital rights management was created and continues to evolve to combat unauthorized use and copying of applications by users. Digital rights management may take a variety of different forms. For example, digital rights management may use a digital watermark, which involves marking an application with hidden and sometimes encrypted data to identify ownership of the application. However, typical digital watermarks may still enable the application to be executed by unauthorized users.

In another example, a certificate was utilized to control access to the application module. The certificate is typically configured as data that may be authenticated to provide access to functionality of an application. For instance, a traditional use of certificates limited access to the application by a client device until a valid certificate was obtained. However, traditional digital certificates were provided by a certificate authority over a network. Therefore, when online access was not available (e.g., the client device was located in a remote location), access to the application module was limited and even prevented altogether.

Additionally, traditional uses of certificates may limit use of “free trial” scenarios used to market the application. For example, traditional processes that were used to obtain certificates typically involved a sometimes lengthy process to supply personally identifiable information. Therefore, users that do not wish to provide this information may choose to forgo a free trial of the application. Additionally, even when users are willing to provide this information they may still become frustrated by an extensive manual entry process, and therefore may also choose to forgo the free trial. Thus, a provider of the application may miss opportunities to expose users to the application by traditional techniques that were used to protect the rights of the provider.

### SUMMARY

Techniques to install an application module and a temporary certificate are described. In an implementation, an application module is installed on a client device. When online access is available, a temporary certificate is obtained anonymously from a service provider to enable one or more online components of the application module for a predetermined amount of time. Thus, the online components of the application module may be made accessible to a user of the client device without providing personally identifiable information. An input may also be received to communicate credentials of the user to obtain a permanent certification. Therefore, access to the online components may also be provided past the predetermined amount of time.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an environment in an exemplary implementation that is operable to install an application module and a temporary certificate.

FIG. 2 is an illustration of another exemplary environment in which a client device associates an application module with a subscription and creates an installer module to install the application module on another client device.

FIG. 3 is a flow diagram depicting a procedure in an exemplary implementation in which an application module is installed and functionality of online components is enabled for a predetermined amount of time through use of a temporary certificate that was obtained anonymously.

FIG. 4 is a flow diagram depicting a procedure in an exemplary implementation in which an application module is associated with a subscription during an installation process of the application module on a client device.

FIG. 5 is a flow diagram depicting a procedure in an exemplary implementation in which a removable computer-readable medium is used to install an application module on a second client device based on an identifier of a permanent license obtained through installation of the application module on a first client device.

The same reference numbers are utilized in instances in the discussion to reference like structures and components.

### DETAILED DESCRIPTION

Overview

Techniques to install an application module and a temporary certificate are described. Digital rights management techniques are typically implemented to combat unauthorized use and copying of application modules by users. However, these techniques may interfere with use of the application by authorized users. For example, a traditional technique collected personally identifiable information from the user to obtain a certificate to enable use of online functionality of an application, such as to obtain updates. Therefore, users that did not wish to provide this information to try the application module (e.g., during a free-trial period) were prevented from use of the application module, which had an adverse affect on the exposure of the application module to potential consumers. Additionally, because this technique typically involved manual entry of the personally identifiable information, users may become frustrated when entering this information, which may further limit exposure of the application module to potential consumers.

Accordingly, techniques are described to install an application module and a temporary certificate. In an implementation, the temporary certificate enables use of online components of an application module and may be obtained anonymously. Therefore, a user does not submit personally-identifiable information in order to obtain access to functionality of the application module. Additionally, the temporary certificate may be obtained “seamlessly” by a user because the user does not have to wait to enter the information in order to use the application module.

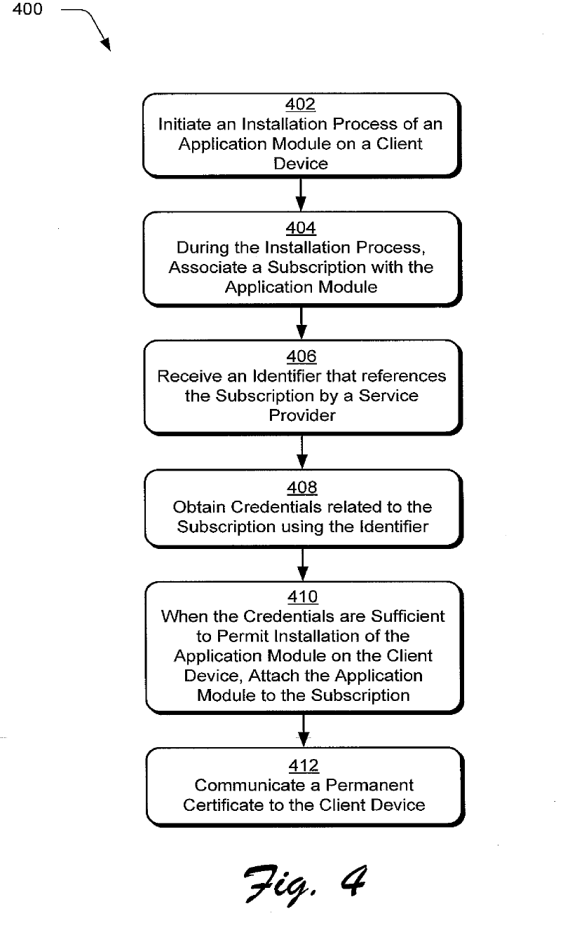

Techniques are also described to efficiently install the application module on a plurality of client devices. For example, a user may have a pre-existing account with a service provider pertaining to a subscription for use of an application module. During an offline installation process of another application module, the user may associate a subscription of the other application module with the subscription in the existing account. An identifier which references this association may then be communicated to the service provider, which is used by the service provider to obtain credentials of the user relating to the subscription. When the credentials are sufficient (e.g., billing information is up-to-date), the other application module is also attached to the subscription. Therefore, a user having a preexisting subscription with a service provider may seamlessly add application modules to the subscription, further discussion of which may be found in relation to FIG. 4.

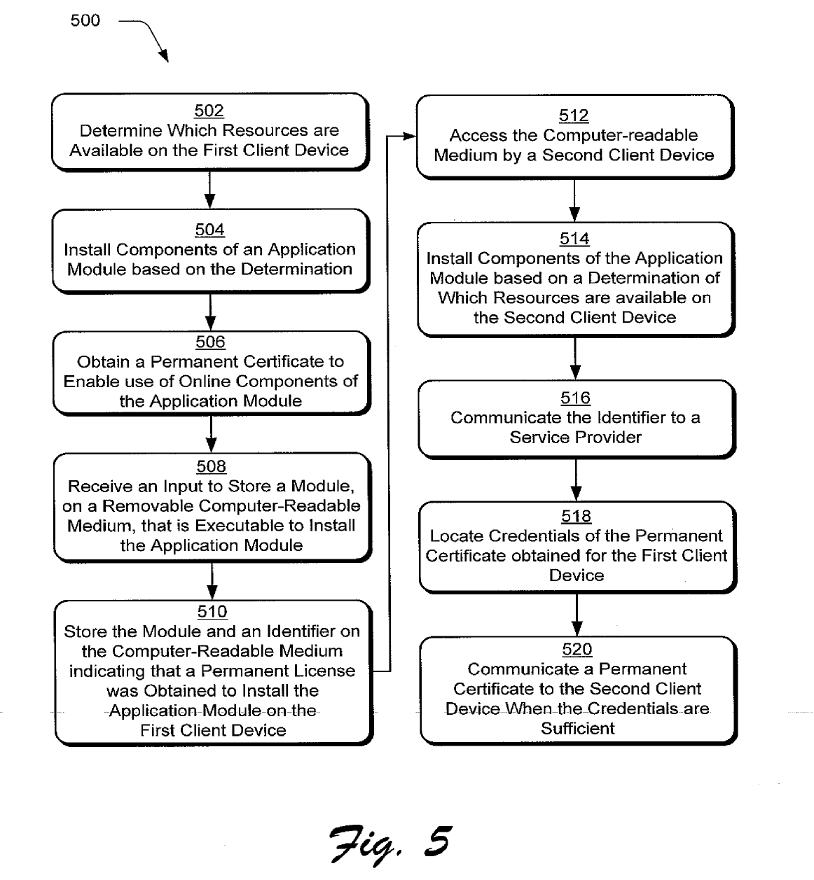

In another example, the user may place an installer module on a removable computer-readable media (e.g., a flash drive) through execution of an application module that is already installed on a first client device. The user may also cause an identifier (e.g., a cookie) to be stored that indicates that a certificate was obtained to install the application module on the first client device. The removable computer-readable medium (e.g., the flash drive) may then be used by the user to install the application module on other client devices. For instance, the installer module may communicate the identifier (e.g., the cookie) to a service provider to retrieve credentials of the user to authorize use of the application module on the other client devices (e.g., provide certificates), add the other application modules installed on the other client devices to a subscription, and so on. Thus, a second client device may obtain a permanent certificate without re-entering personally identifiable information or authenticating with a service provider, which results in a seamless process to the user. For instance, in a case of a small business where the owner does not want to share logon information with employees, the owner can have the application module installed on a wide variety of other devices without personally waiting through each installation process. Further discussion of use of a removable computer-readable medium to install an application module may be found in relation to FIG. 5.

In the following discussion, an exemplary environment is first described which is operable to provide application module installation techniques. Exemplary procedures are then described which are operable in the described environment, as well as in other environments.

Exemplary Environment

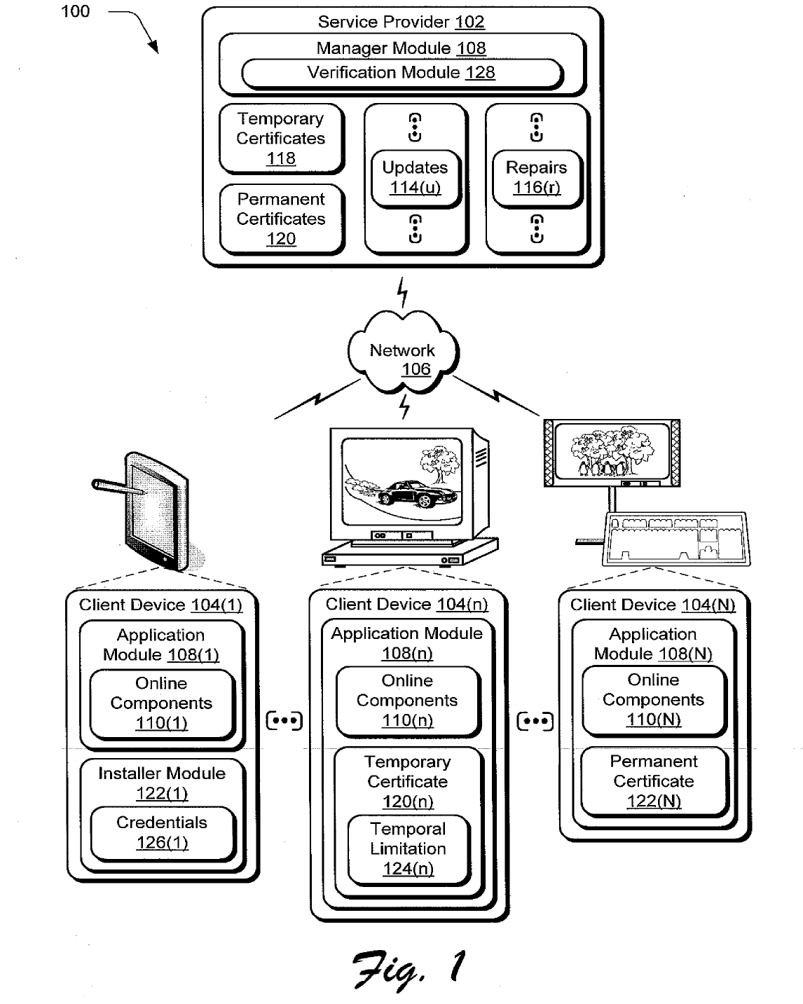

FIG. 1 is an illustration of an environment 100 in an exemplary implementation that is operable to install an application module and a temporary certificate. The illustrated environment 100 includes a service provider and a plurality of clients 104(1), . . . , 104(n), . . . , 104(N), each of which are communicatively coupled, one to another, over a network 106.

The client devices 104(1)-104(N) may be configured in a variety of ways. For example, the client devices may be configured as a personal digital assistant that is capable of communicating over the network 106 (as illustrated by client device 104(1)), a desktop computer (as illustrated by client devices 104(n), 104(N)), a mobile station, an entertainment appliance, a set-top box communicatively coupled to a display device, a wireless phone, a game console, and so forth. Thus, the client devices 104(1)-104(N) may range from full resource devices with substantial memory and processor resources (e.g., personal computers, game consoles) to a low-resource device with limited memory and/or processing resources (e.g., traditional set-top boxes, hand-held game consoles).

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks. For instance, the client devices 104(1)-104(N) may be communicatively coupled via a corporate Intranet to communicate, one with another. The service provider 102 may also be communicatively coupled in this instance to the clients 104(1)-104(N) over the Internet. A wide variety of other instances are also contemplated.

The service provider 102 is configured to provide functionality relating to applications modules 108(1)-108(N), and more particularly to online components 110(1)-110(N) of the application modules 108(1)-108(N). For example, the online components 110(1)-110(N) may be configured to communicate over the network 106 with a manager module 112 of the service provider 102 to obtain one or more updates 114(u), where “u” can be any integer of one to “U”. The updates 114(u) may be configured as service packs and so on to update functionality of the application modules 108(1)-108(N).

In another example, the online components 110(1)-110(N) are configured to communication telemetry data relating to the operation of the application module 108(1)-108(N) and client device 104(1)-104(N) to the service provider 102. Therefore, the service provider 102, through execution of the manager module 112, may determine whether repairs 116(r) (where “r” can be any integer from one to “R”) are desirable for each the application modules 108(1)-108(N) and communicate the repairs 116(r) where desired. The repairs 116(r), for instance, may relate to configuration settings of the application modules 108(1)-108(N). A variety of other instances are also contemplated.

As previously described, digital rights management (DRM) techniques are typically implemented to combat unauthorized use and copying of application modules by users. However, traditional DRM techniques interfered with use of the application by authorized users. Accordingly, techniques are described in which the service provider 102 may use temporary and permanent certificates 120, 122 to manage use of the online components 110(1)-110(N) of the application modules 108(1)-108(N) by the client devices 104(1)-104(N).

Through use of the temporary certificate 120, the service provider 102 may give a user access to the online components 110(1)-110(N) for a predetermined amount of time, during which, the user may decide whether “permanent” (e.g., full) access is descried. Additionally, the use of the temporary certificates 118 may enable users of the client devices 104(1)-104(N) to install and try the application modules 108(1)-108(N) without submitting personally identifiable information and with engaging in a prolonged process to enter the information.

Each of the client devices 104(1), 104(n), 104(N) is illustrated in FIG. 1 as being at different respective “stages” in an installation process of the respective application modules 108(1), 108(n), 108(N). Client device 104(1), is illustrated as including an installer module 122(1) that is executable to install the application module 108(1) on the client device 104(1). For example, the installer module 122(1) may determine resources of the client device 104(1) (e.g., processor, memory, display, network connection, peripheral devices, drivers, other modules installed, and so on) and install corresponding components of the application module 108(1). Therefore, an application module 108(1) as installed on one client device may include different components than those installed on another client device. Thus, the application module, when copied to another client device, may lose function of one or more components of the application module, such as due to incompatibilities, conflicts in configuration settings, and so on.

The application module 108(1)-108(N), however, is configured such that a certificate is used to enable the functionality of the online components 110(1). Since application module 108(1) does not have access to a certificate on client device 104(1), however, the online components 110(1) are disabled.

Client device 104(n), as illustrated, includes an application module 108(n) having online components 110(n) that are enabled through use of a temporary certificate 120(n). The temporary certificate 120(n) includes a temporal limitation 124(n) that limits use of the temporary certificate 120(n) to a predetermined amount of time, and therefore use of the online components 110(n) to the predetermined amount of time.

The temporary certificate may be obtained by the client device 104(n) in a variety of ways. For example, the application module 108(n), when being installed on the client device 104(n) by an installer module may poll the service provider 102 to obtain a temporary certificate 118. In an implementation, this polling is performed anonymously such that personally-identifiable information relating to an entity (e.g., a user, business, and so on) that operates the client device 104(n) is not provided. Rather, an identifier may be provided by the client device 104(n) (e.g., a Media Access Control (MAC) address) to differentiate the client device 104(n) from other client devices, e.g., client devices 104(1), 104(N). Additionally, because the personally-identifiable information is not provided, the user is not confronted with a sometimes-lengthy process to manually enter the personally-identifiable information, thereby increasing a likelihood that a user will participate in a free-trial offer.

In another example, the temporary certificate 120(n) may be written with the application module 108(n) on the client device 104(n) by a manufacturer. For instance, the temporary certificate 120(n) may be obtained by the manufacturer such that the online components 110(n) are enabled as soon as a consumer received the client device 104(n) for a predetermined amount of time. A variety of other examples are also contemplated.

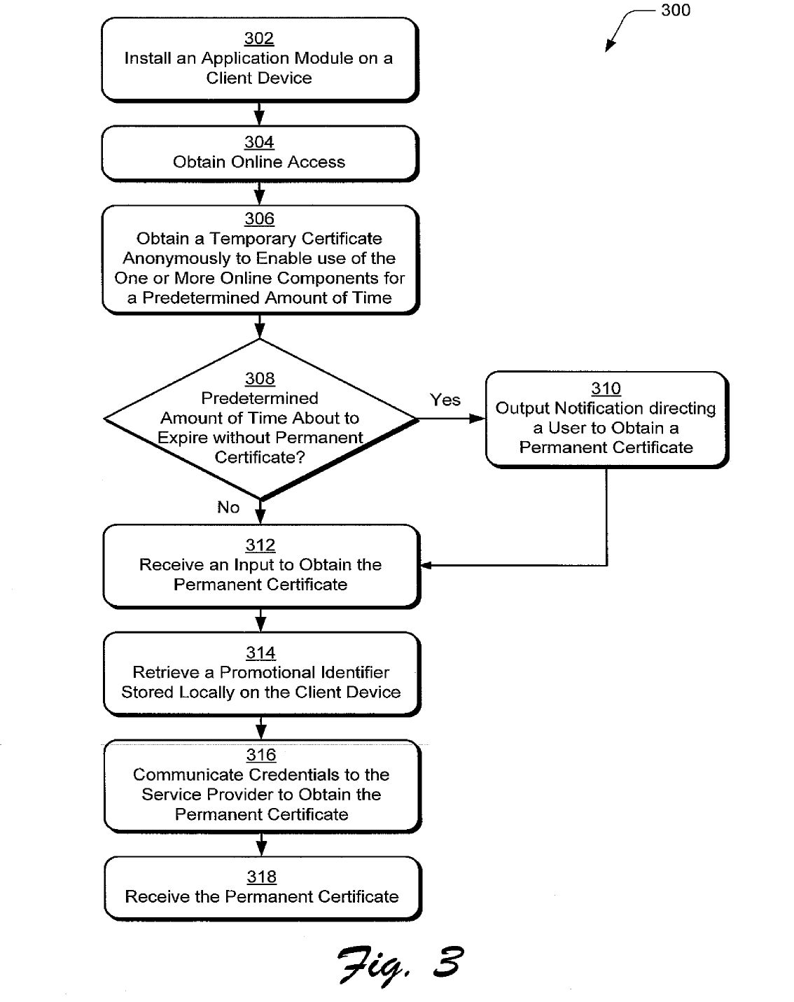

Client device 104(N) is illustrated as including an application module 108(N) having online components 110(N) that are enabled through use of a permanent certificate 122(N) obtained from the service provider 102. The permanent certificate 122(N), for instance, may be used to enable use of the online components 110(n) past the temporal limitation 124(n) specified by the temporary certificate 120(n). For example, the permanent certificate 122(N) may be linked with a subscription to permit use of the online components 110(N) while the subscription is valid. A variety of other examples are also contemplated, further discussion of which may be found in relation to FIG. 3.

As previously described, in an implementation client devices 104(1)-104(N) may obtain temporary certificates 118 anonymously, and therefore the user does not spend time entering personally-identifiable information. However, this may open the service provider 102 to attacks by malicious parties, such as by sending a multitude of requests for temporary certificates 118 with the hope of “crashing” the service provider 102. Accordingly, the service provider 102 may also employ a verification module 128 to verify requests for temporary certificates 118 based on indications provided in the requests. For example, a “proof-of-work” technique may be employed in which the client devices 104(1)-104(N) submit an indication indicating a computation having a significant amount of complexity has been performed.

Additionally, the verification module 128 may be configured to “scale” when confronted with a possible attack. For instance, when a significant number of request are received in a relatively-short amount of time, the verification module may scale the amount of computational proof (i.e., the complexity of the proof and therefore the corresponding amount of resources that are to be used to complete the proof) as the number increases. Although a computational proof has been described for use by the verification module, a variety of other examples are also contemplated, such as user entry of a code displayed to the user that is not intelligible by a computer.

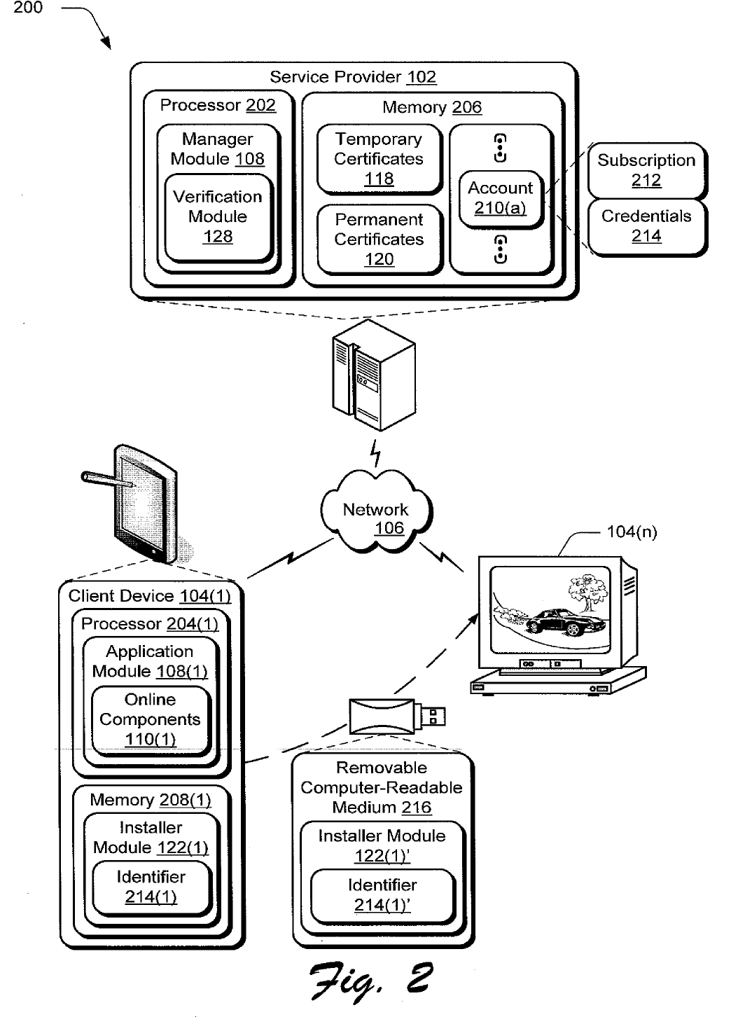

FIG. 2 is an illustration of another exemplary environment 200 in which the client device 104(1) is configured to associate an application module with a subscription and to create an installer module to install the application module on another client device. The service provider 102 (illustrated as being implemented by a server) and the client device 104(1) are illustrated as having respective processors 202, 204(1) and memory 206, 208(1).

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 206, 208 is shown, respectively, for the service provider 102 and the client 104(n), a wide variety of types and combinations of memory may be employed, such as random access memory (RAM), hard disk memory, removable medium memory, and other types of computer-readable media.

In an implementation, the application module 108(1) is configured to employ techniques to improve efficiently in the installation of the application module 108(1). For example, a user may initiate an installation process of application module 108(1) of the service provider 102 through execution of the installer module 122(1). The user, however, may have a pre-existing account 210(a) (where “a” can be any integer from one to “A”) with the service provider 102, such as for use of the application module that is already installed on the client device 104(1) according to a subscription 212.

During the installation process, the user may associate a subscription of the application module 108(1) with the subscription 212 in the pre-existing account 210(a). For example, the installer module 122(1) may output a user interface that queries the user as to whether the application module 108(1) is to be associated with the subscription 212 in the account 210(a).

An identifier 214(1) which references this association may then be communicated to the service provider 102 by the installer module 122(1). The identifier 214(a) is used by the service provider 102 to obtain credentials 214 of the user relating to the subscription. The credentials 214 may be used by the service provider 102 (e.g., through execution of the manager module 108(1)) to determine whether conditions have been met to add the application module 108(1) to the subscription 212 in the account 210(a). If so, the service provider 102 may communicate a permanent certificate 120 to the client device 104(1), thereby making the registration and association with the subscription 212 seamless to the user.

In another example, the application module 108(1) is installed on a client device 104(1) according to resources of the client device 104(1). The installer module 122(1), for instance, may take into account the resources of the client device 104(1). If the user wishes to install the application module 108(1) on another client device (e.g., client device 104(n)), the application module 108(1) is executed to store an installer module 122(1)′ and the identifier 214(1)′ on a removable computer-readable medium 216, such as a flash drive, compact-disc read-only memory (CD-ROM), digital video disc (DVD), and so on.

The removable computer-readable medium 216 may then be physically connected to the client device 104(n) to install the application module. For instance, the installer module 122(1)′, when executed by the client device 104(n), may communicate the identifier 214(1)′ to the service provider 102 to retrieve credentials 214 from the user's account 210(a). In an implementation, the manager module 108(1) automatically adds the application module 108(n) installed on the client device 104(n) to the subscription 212 with minimal (e.g., a confirmation screen) or no user input. Therefore, the removable computer-readable medium 216 may be used by the user to install the application module on numerous client devices in an efficient manner, further discussion of which may be found in relation to FIG. 5.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the installation techniques described below are platform-independent, meaning that the techniques may be implemented on a variety of commercial computing platforms having a variety of processors.

Exemplary Procedures

The following discussion describes installation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environments 100, 200 of FIGS. 1 and 2.

FIG. 3 depicts a procedure 300 in an exemplary implementation in which an application module is installed and functionality of online components is enabled for a predetermined amount of time through use of a temporary certificate that was obtained anonymously. An application module is installed, on a client device (block 302), having one or more online components that are disabled. For example, the online components may relate to functionality to obtain software updates, broadcast messaging, communication of telemetry data of a client device, and so on. Additionally, the application module may be installed on the client device when online access is not available. For example, when the application module is installed on a client device (e.g., a laptop computer) while the user is in a remote location, at which, network access is not obtainable (e.g., an airplane).

Online access is then obtained (block 304). Continuing with the previous example, the user may exit the airplane and power-on the laptop in an airport that supplies wireless network access. The laptop, while powered on, may periodically poll for network access and once obtained, attempt to locate a website of the service provider 102.

A temporary certificate is obtained anonymously to enable use of the one or more online components of the application module for a predetermined amount of time (block 306). An installer module 122(1), for instance, may communicate a globally unique identifier (e.g., a Media Access Control (MAC) address) to the service provider 102 to identify the client device 104(1) from other client devices 104(1). Therefore, even though the client device in this instance may be identified from other clients device, an entity that operates that client device (e.g., a user, business, and so on) remains anonymous. In an implementation, the temporary certificate is obtainable by the client device free-of-charge and therefore provides the user with a free-trial of the application module.

The installer module 122(1) may also include a result of a proof of work (POW) algorithm to verify that the client device 104(1) is not engaging in a denial of service (DOS) attack. As previously described, the manager module 108 may employ the verification module 128 to verify that a minimum amount of resources (i.e., a threshold amount) were expended by the client device 104(1) in order to request the temporary certificate 118. Therefore, this minimum amount of resources may remain transparent to a user of a client device sending a single request, but may become onerous to a malicious party attempting to send a multitude of requests.

Additionally, this threshold amount may be increased as the verification module 128 is confronted with increasing numbers of requests in a given amount of time. Therefore, the verification module 128 may protect the service provider 102 from a denial of service attack by requiring ever increasing expenditures of resources in order to send additional requests for temporary certificates. Although proof of work verification techniques have been described, a variety of other verification techniques are also contemplated without departing from the spirit and scope thereof, such as monetary attachment (e.g., an e-stamp), and so on.

A determination is made as to whether the predetermined amount of time is about to expire without a permanent certificate (decision block 308). For example, a second amount of time that is less than or equal to the predetermined amount of time specified by the temporary certificate may be counted. The permanent certificate is a certificate that enables use of the one or more online components past the predetermined amount of time. Therefore, when this second amount of time expires and a permanent certificate has not been obtained (“yes” from decision block 308), a notification is output directing a user to obtain the permanent certificate (block 310). For example, the application module may periodically poll for access to the service provider 102 (e.g., determine whether online access is available and if so, locate the service provider 102) to provide a user with an opportunity to purchase the permanent certificate. A variety of other examples are also contemplated.

An input is received to obtain the permanent certificate (block 312). Continuing with the previous example, the user may select a link in the notification to obtain the permanent certificate, may manually request the permanent certificate (“no” from decision block 308), and so on.

In response to the input, a promotional identifier stored locally on the client device is retrieved (block 314). The promotional identifier, for instance, may be stored by a manufacturer of the client device that also installed the application module. Therefore, when the input is received, the promotional identifier may be retrieved automatically with or without the user's knowledge or her input. For example, the promotion may relate to a special offer provided by the manufacturer, such as may offer a discounted rate to use the application module. In another example, the promotional identifier may direct the client device to a specific version of an application module, such as to an application module branded by a manufacturer of the client device. In another implementation, the promotional code is uploaded while obtaining the temporary certificate in block 306. The promotional code is then placed in the temporary certificate for safe storage and later retrieval to obtain the permanent certificate. A variety of other examples are also contemplated.

The credentials are then communicated to the service provider to obtain the permanent certificate (block 316). For example, the credentials may be manually entered by a user, such as user name, billing information, and so on. In another example, the reference is made to a preexisting account such that the credentials may be retrieved by the service provider 102 through use of the identifier. When the credentials are sufficient, the client device receives the permanent certificate (block 318), and therefore use of the online components is enabled past the amount of time specified in the temporary certificate.

FIG. 4 depicts a procedure 400 in an exemplary implementation in which an application module is associated with a subscription during an installation process of the application module on a client device. An installation process of an application module is initiated on a client device (block 402). For example, a user may provide an input to execute an installer module 122(1) on the client device 104(1).

During the installation process, a subscription is associated with the application module (block 404). The installer module 122(1), for instance, may examine the client device and determine that another application module of the service provider is already installed. The installer module 122(1) may then query the user as to whether the user wishes to associate the application module to be installed with the subscription of the application module already installed on the client device. In another instance, the installer module may query the user to enter information relating to a current subscription, if any, that the user has with the service provider 102. A variety of other instances are also contemplated.

The service provider may then receive an identifier that references the association (block 406) and use the identifier to obtain credentials related to the subscription (block 408). When the credentials are sufficient (e.g., a current subscription, up-to-date billing information, and so on), the application module is attached to the subscription (block 410) and a permanent certificate is provided to client device (block 412). Therefore, in this instance the client device may seamlessly obtain a permanent certificate without transitioning through a temporary certificate. However, in an implementation a temporary certificate is provided to the client device when the credentials are not sufficient (e.g., the billing information is out-of-date) therefore providing a user of the client device access to the application module for the predetermined amount of time.

FIG. 5 depicts a procedure 500 in an exemplary implementation in which a removable computer-readable medium is used to install an application module on a second client device based on an identifier of a permanent license obtained through installation of the application module on a first client device. A determination is made as to which resources are available on a first client device (block 502) and components of an application module are installed on the first client device based on the determination (block 504). For example, an installer module may be executed to determine processing resources, memory resources, software resources (e.g., drivers), peripheral devices, and so on of the client device and install and configure components of the application module based on these resources. Thus, the application module is “customized” to the resources of the first client device.

A permanent certificate is obtained to enable use of online components of the application module (block 506). For instance, the techniques described in relation to the procedures 300, 400 of FIGS. 3 and 4 may be utilized to obtain the permanent certificate. A variety of other implementations are also contemplated.

An input is received to store a module, on a removable compute-readable medium, that is executable to install the application module (block 508). The user, for instance, may interact with the installed instance of the application module 108(1) on the client device 104(1) to cause the client device to create another instance of the installer module 122(1)′ on the removable computer-readable medium 216.

The module and an identifier are stored on the removable computer-readable medium indicating that a permanent license was obtained to install the application module on the first client device (block 510). The user may then use the removable computer-readable medium to install the application module on other client devices.

A second client device, for instance, may access the removable computer-readable medium (block 512) after the user physically and communicatively couples the removable computer-readable medium (e.g., “plugging in” a flash drive) to the second client device. Components of the application module are installed on the second client device based on a determination of which resources are available on the second client device (block 514). For example, the components may also be included on the removable computer-readable medium and copied to the client device as warranted. In another example, the installer module 122(1)′ may retrieve components from over the network (e.g., the service provider 102) for installation on the client device 104(n). Like before (e.g., blocks 502, 504), the application module may be “customized” for operation on the second client device based on the resources (e.g., hardware, software) of the second computer device.

The identifier is then communicated to a service provider (block 516), which is used to locate credentials of the permanent certificate obtained for the first client device (block 518). When the credentials are sufficient, a permanent certificate is provided to client device. For example, the credentials may be considered sufficient when the permanent certificate is up-to-date and the user has authorized additional installations of application modules. Therefore, in this example the use may attach the removable computer-readable medium to successive client devices to install the application module with minimal effort.

Although communication of an identifier has been described to ease installation of the application module, in a further instance, the installer module 122(1) may locate “cached credentials” that are server authenticated pieces of data that were signed by an initial machine, but may be used to install the application module on another machine. In other words, the identifier in this instance includes the credentials themselves. A variety of other instances are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
installing an application module on a client device;
when online access is available, obtaining a temporary certificate anonymously from a service provider to enable use of one or more components of the application module for a predetermined amount of time; and
receiving an input to communicate credentials of a user to obtain a permanent certificate.

2. A method as described in claim 1, wherein the installing is performed when online access is not available.

3. A method as described in claim 1, wherein the obtaining is performed anonymously such that personally identifiable information relating to an entity that uses the client device is not provided.

4. A method as described in claim 3, wherein the entity is a user or a business.

5. A method as described in claim 1, wherein the obtaining is performed anonymously such that personally-identifiable information relating to an entity that maintains the client device is not provided.

6. A method as described in claim 1, wherein the online components are configured to retrieve updates of the application module over a network.

7. A method as described in claim 1, wherein the online components are configured to retrieve repairs to configuration of the application module over a network.

8. A method as described in claim 1, wherein the online components are configured to upload telemetry data to the service provider over a network.

9. A method as described in claim 1, further comprising obtaining a permanent certificate associated with a subscription that enables use of the one or more online components past predetermined amount of time.

10. A method comprising:
receiving a request having an identifier that references an association of an application module with a subscription, wherein the association was made during an installation process of the application module on a client device;
obtaining credentials of a user related to the subscription using the identifier; and
when the credentials the credentials are sufficient, attaching the application module to the subscription.

11. A method as described in claim 10, wherein the receiving is performed while the client device does not have online access.

12. A method as described in claim 10, further comprising forming a communication that includes a permanent certificate for communication to the client device when the credentials are sufficient.

13. A method as described in claim 10, further comprising forming a communication that includes a temporary certificate for communication to the client device when the credentials are insufficient.

14. A method as described in claim 10, further comprising verifying an indication included in the request to protect a service provider that performs the receiving, the obtaining and the attaching from attack.

15. A method as described in claim 14, wherein the verifying is scalable such that an amount of proof of a proof-of-work algorithm performed to generate the indication varies.

16. One or more removable computer-readable media comprising an identifier indicating that a certificate was obtained to install an application module on a first client device and an installer module that is executable by a second client device to:
install the application module based on configuration of the second client device; and
form a communication having the identifier to be communicated to a service provider to locate credentials to obtain a certificate to install the application module on the second client device.

17. One or more computer-readable media as described in claim 16, wherein the configuration of the first client device is different from the second client device such that the application mode of the first client device, when copied to the second client device, loses function of one or more components of the application module.

18. One or more computer-readable media as described in claim 16, wherein when the credentials are not sufficient to obtain the certificate, a temporary certificate is obtained that enables use of one or more online components of the application module for a predetermined amount of time.

19. One or more computer-readable media as described in claim 16, wherein the installer module and the identifier were stored on the computer-readable media by the application module installed on the first client device.

20. One or more computer-readable media as described in claim 16, wherein the installer module is executable to install components of the application module obtained remotely over a network that are not included on the computer-readable media.
